(19) United States
(12) Patent Application Publication
(10) Pub. No.: US 2005/0025480 A1
(43) Pub. Date: Feb. 3, 2005

(54) Circuit device dedicated in remote control switch

(76) Inventor: Chung-Kai Yeh, Taipei Hsien (TW)

Correspondence Address: Chung-Kai Yeh, 235 Chung - Ho, Box 8-24, Taipei, TW

(21) Appl. No.: 10/632,163

(22) Filed: Aug. 1, 2003

(51) Int. Cl. H04B 10/08

(52) U.S. Cl. 398/12

(57) ABSTRACT

A circuit device dedicated in a remote control switch comprises the following elements. A voltage conversion circuit serves for converting AC input current to DC current. A photo sensor serves for sensing a laser light and receiving the DC current from the voltage conversion circuit. A switch button generates a trigger signal as the photo sensor senses an input laser light. A signal integrated circuit is turned on as the signal integrated circuit receives the trigger signal from the switch button. A flip-flop is capable of changing state as the signal integrated circuit is turned on. A relay serves for changing the operation state when the relay receives an input signal from the signal integrated circuit, thereby, the electric device connected to the flip-flop can be switched on or off when the flip-flop changes state.

### FIELD OF THE INVENTION

The present invention relates to optics, and particularly to a circuit device dedicated in a remote control switch

### BACKGROUND OF THE INVENTION

With reference to FIG. 1, a prior art power switch is illustrated. In the prior art, a hand 2′ controls the conduction of power to operate an electric device. However the conventional operation is inconvenient. To improve this defect, wireless infrared remote controllers are developed, as shown in FIG. 2. In the infrared remote controller has an infrared remote control switch 4′ for controlling infrared 3′ to impinge to the switch button 5′ so as to conduct power. Thereby, an electric device can be operated. In this infrared remote controller, an infrared frequency has a corresponding button and a plurality of infrared frequencies will need a plurality of buttons. Thereby, the remote controller has a larger volume. Not only the operation is inconvenient, but also the user must remember the function of each button.

### SUMMARY OF THE INVENTION

Accordingly, the primary object of the present invention is to provide a circuit device dedicated in a laser remote control switch which comprises the following elements. A voltage conversion circuit serves for converting AC input current to DC current. A photo sensor serves for sensing a laser light and receiving the DC current from the voltage conversion circuit. A switch button generates a trigger signal as the photo sensor senses an input laser light. A signal integrated circuit is turned on as the signal integrated circuit receives the trigger signal from the switch button. A flip-flop is capable of changing state as the signal integrated circuit is turned on. A relay serves for changing the operation state when the relay receives an input signal from the signal integrated circuit; thereby, the electric device connected to the flip-flop can be switched on or off when the flip-flop changes state.

The various objects and advantages of the present invention will be more readily understood from the following detailed description when read in conjunction with the appended drawing.

### BRIEF DESCRIPTION OF THE DRAWINGS

FIG. 1 shows the prior art manual pressing button.

FIG. 2 shows the prior art infrared switch button.

FIG. 3 shows the schematic view of the present invention.

FIG. 4 shows the circuit of the voltage conversion circuit of the present invention.

FIG. 5 shows the circuit embodiment of the present invention.

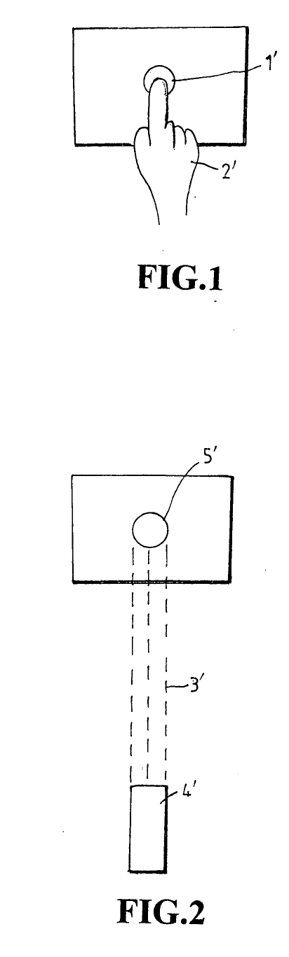

### DETAILED DESCRIPTION OF THE PREFERRED EMBODIMENTS

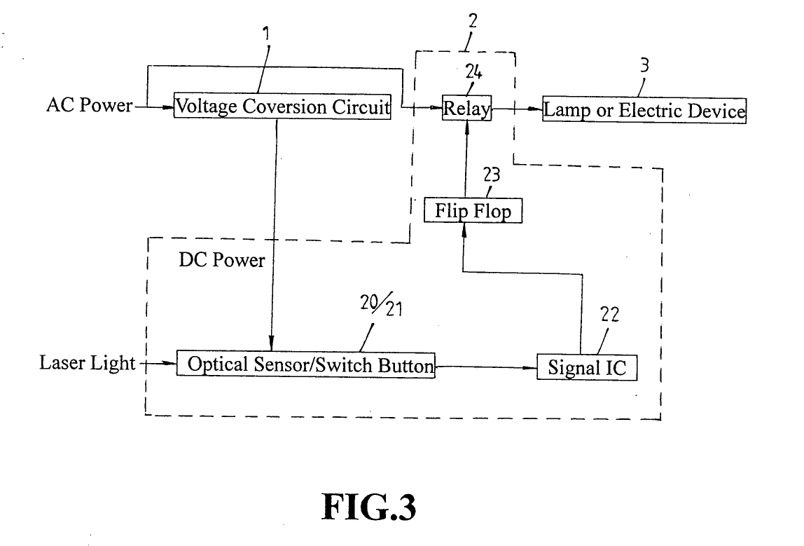

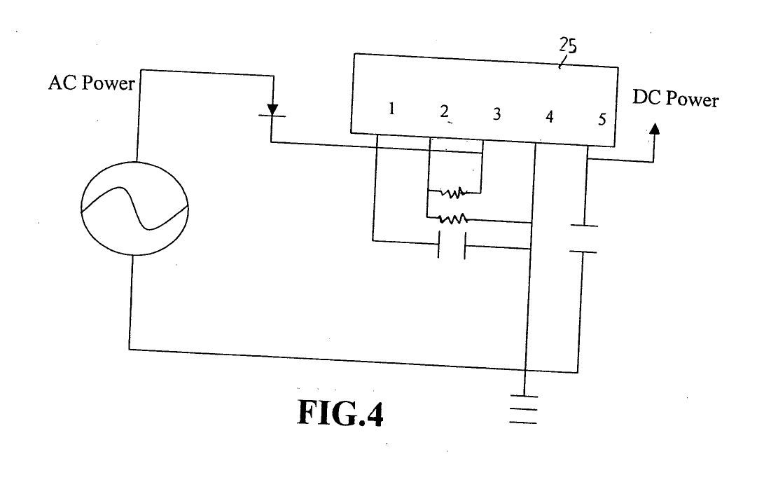

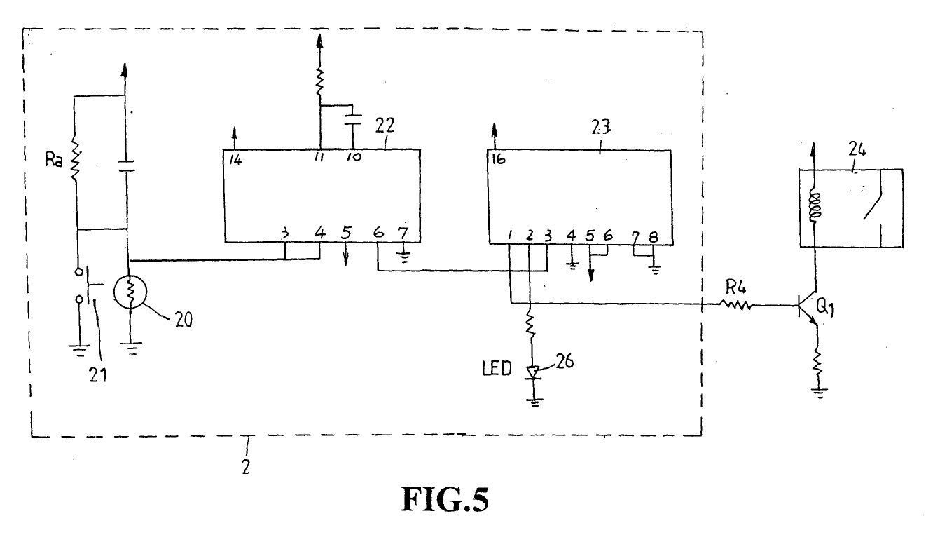

Referring to FIGS. 3-5, the schematic view and circuit diagrams of the present invention are illustrated. The circuit device dedicated in a laser remote control switch of the present invention includes a voltage conversion circuit 1 and an optical controlled relay 2. The optical controlled relay 2 includes a photo sensor 20, a switch button 21, a signal integrated circuit 22, a flip-flop 23 and a relay 24. In operation, the voltage conversion circuit 1 serves to convert AC current to DC current (alternate current into direct current). The voltage conversion circuit 1 has a current regulator 25, as shown in FIG. 4, for adjusting the input current. The output DC current is supplied to the optical controlled relay 2.

The photo sensor 20 serves for sensing a laser light and receives the DC current from the voltage conversion circuit 1. Input laser will cause the photo-resistor and voltage of the photo sensor 20 to become smaller.

Then the switch button 21 generates a trigger signal as the photo sensor 20 senses an input laser light.

The signal integrated circuit 22 is turned on as the signal integrated circuit 22 receives the trigger signal from the switch button 21.

The flip-flop 23 changes state as the signal integrated circuit 22 turned on.

The relay 24 changes the operation state when the relay 24 receives an input signal from the signal integrated circuit 22. Thereby, the electric device connected to the flip-flop 23 can be switched on or off when the flip-flop 23 changes state.

In the present invention, the optical controlled relay 2 is actuate when it is radiated by laser without needing to adjust the receive frequency or the focus to the laser.

From above description, it is known that the present invention has the following advantages. The size of the remote controller is smaller. Only one switch is necessary for receiving the laser light. Since the operation of the present invention is independent from the frequency of the laser, the optical controlled relay is actuate when it is radiated by laser without needing to adjust the receive frequency or the focus to the laser.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A circuit device dedicated in a remote control switch comprising:
a voltage conversion circuit for converting AC input current to DC current;
an optical controlled relay comprising:
a photo sensor for sensing a laser light and receiving the DC current from the voltage conversion circuit; wherein input laser will cause the photo-resistor and voltage of the photo sensor to be smaller;
a switch button generating a trigger signal as the photo sensor senses an input laser light;
a signal integrated circuit which is turned on as the signal integrated circuit receives the trigger signal from the switch button;
a flip-flop capable of changing state as the signal integrated circuit is turned on;
a relay for changing the operation state when the relay receives an input signal from the signal integrated circuit; thereby, the electric device connected to the flip -flop can be switched on or off when the flip-flop changes state.

2. The circuit device dedicated in a remote control switch as claimed in claim 1, wherein the optical controlled relay is actuate when it is radiated by laser without needing to adjust the receive frequency or the focus to the laser.
